(19) United States
(12) Patent Application Publication
(10) Pub. No.: US 2014/0333988 A1
(43) Pub. Date: Nov. 13, 2014

(54) COLOR FILTER STRUCTURE AND MANUFACTURING METHOD THEREOF

(71) Applicant: E Ink Holdings Inc., Hsinchu (TW)

(72) Inventors: Tai-Yuan LEE, HSINCHU (TW); Po-Yuan LO, HSINCHU (TW)

(73) Assignee: E Ink Holdings Inc., Hsinchu (TW)

(21) Appl. No.: 14/161,700

(22) Filed: Jan. 23, 2014

(30) Foreign Application Priority Data
May 8, 2013 (TW) 102116371

(51) Int. Cl. G02B 5/20; B29C 59/04; B29D 11/00; G02F 1/167; G02F 1/1335

(52) U.S. Cl. CPC G02B 5/201; G02F 1/167; G02F 1/133514; B29D 11/00634; B29C 59/04
USPC 359/296; 359/891; 264/1.7; 216/24

(57) ABSTRACT

The disclosure provides a color filter structure used to a reflective display. The color filter structure includes a transparent substrate, a plurality of color resists, a plurality of light-impermeable structures and a reflective layer. The transparent substrate has a top surface and a bottom surface, and the color resists are positioned on the top surface of the transparent substrate. The light-impermeable structures are positioned in the transparent substrate, in which the adjacent two color resists are separated by one of the light-impermeable structures. The reflective layer is positioned on the bottom surface of the transparent substrate. And the method for manufacturing the color filter structure is also disclosed herein.

This application claims priority to Taiwanese Application Serial Number 10216371 filed May 8, 2013, which is herein incorporated by reference.

### BACKGROUND

1. Technical Field

The present disclosure relates to a color filter structure for a reflective display device, and more particularly, to a color filter structure having light-impermeable structures.

2. Description of Related Art

Generally, a color display device generates full-color performance by controlling light through color-resist layers on a color filter. The color-resist layers of the color filter normally include three primary colors of red, green and blue, and black matrixes. In which, the black matrixes are positioned to space the adjacent color-resist layers, and to prevent the light leakage of the adjacent color-resist layers, so as to enhance the color contrast.

However, the conventional black matrixes are positioned on the surface of the transparent substrate, which can only block part of the scattered light from outside of the transparent substrate. When another part of the scattered light from the outside of the transparent substrate, the light in the transparent substrate may be reflected and scattered, which results in color shift and decreases the color and optical performance of the display device.

FIG. 1 is a schematic view of a conventional color filter structure 100 for a reflective display device, which includes a transparent substrate 110, a first color resist 120a, a second color resist 120b, a plurality of black matrixes 130 and a reflective layer 140. In FIG. 1, the transparent substrate 110 has a top surface 111 and a bottom surface 112. The first color resist 120a, the second color resist 120b and the black matrixes 130 are positioned on the top surface 111 of the transparent substrate 110. The black matrix 130 separate the first color resist 120a and the second color resist 120b apart. And the reflective layer 140 is positioned on the bottom surface 112 of the transparent substrate 110.

When an extraneous light 150a transmits the first color resist 120a into the transparent substrate 110, the extraneous light 150a may change to be a first chromatic light 150b. In which, the first chromatic light 150b has the color of the first color resist 120a. Then, the first chromatic light 150b is reflected by the reflective layer 140, and then is transmitted through the second color resist 120b to form a second chromatic light 150c. In FIG. 1, θ is the incidence angle of the first chromatic light 150b. The second chromatic light 150c has a mixed color of the first resist 120a and the second color resist 120b, rather than the color of the second color resist 120b. As such, the aforementioned color shift occurs.

Therefore, there is a need for an improved color filter structure to solve the color shift met in the art.

### SUMMARY

The present disclosure provides a color filter structure and a manufacturing method thereof, to solve the color shift in the conventional color filter structure, and enhance the color and optical performance of the display device.

One embodiment of the present disclosure is to provide a color filter structure for a reflective display device. The color filter structure comprises a transparent substrate, a plurality of color resists, a plurality of light-impermeable structures and a reflective layer.

The transparent substrate has a top surface and a bottom surface, and the color resists are positioned on the top surface of the transparent substrate. The light-impermeable structures are positioned in the transparent substrate, wherein two of the adjacent color resists are separated by one of the ht-impermeable structures. The reflective layer is positioned on the bottom surface of the transparent substrate.

According to one embodiment of the present disclosure, the top surface of the transparent substrate further comprises a plurality of recess structures, and at least one light-impermeable material is filled into the recess structures to form the light-impermeable structures.

According to one embodiment of the present disclosure, the color filter structure further comprises a distance between the bottom of the ht-impermeable structure and the bottom surface of the transparent substrate, to prevent the transmission of reflective light. According to another embodiment of the present disclosure, the distance is equal to or less than 10 μm.

Another embodiment of the present disclosure is to provide a method for manufacturing a color filter structure. The steps of the method comprise that, a transparent substrate is first provide, which has a top surface and a bottom surface, and then a plurality of recess structures are formed in the top surface of the transparent substrate. A light-impermeable material is filled into the recess structures. And then, a plurality of the color resists are formed in the top surface of the transparent substrate, wherein two of the adjacent color resists are separated by the light-impermeable material filled in the recess structures. And a reflective layer is formed on the bottom surface of the transparent substrate.

According to one embodiment of the present disclosure, the transparent substrate is made of glass or a flexible material.

According to one embodiment of the present disclosure, when the transparent substrate is made of glass, the step of forming the recess structures comprises an etching method.

According to one embodiment of the present disclosure, when the transparent substrate is made of the flexible material, the step of forming the recess structures comprises a rolling forming method.

According to one embodiment of the present disclosure, the flexible material is polymethylmethacrylate (PMMA), polycarbonate (PC), polyethylene terephthalate (PET) or polyimide (PA).

According to one embodiment of the present disclosure, the step of filling a light-impermeable material into the recess structures comprises a printing process or a filling process.

According to one embodiment of the present disclosure, the light-impermeable material is in a single color or vertically gradated colors.

According to one embodiment of the present disclosure, the color of the light-impermeable material is white or black.

According to one embodiment of the present disclosure, the light-impermeable material is a resin or chromium oxide (Cr₂O₃).

According to one embodiment of the present disclosure, the color resists comprises red resists, green resists and blue resists.

According to one embodiment of the present disclosure, the reflective layer is a metal layer or an electro-phoretic display film.

According to one embodiment of the present disclosure, the color filter structure further comprises a distance between the bottom of the light-impermeable structure and the bottom surface of the transparent substrate, to prevent the transmission of reflective light. According to another embodiment of the present disclosure, the distance is equal to or less than 10 m.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a schematic view of a conventional color filter structure 100 for a reflective display device;

FIG. 2A is a schematic view of a color filter structure 200a according to one embodiment of the present disclosure;

FIG. 2B is a schematic view of a color filter structure 200b according to one embodiment of the present disclosure; and

FIG. 3A˜3E are schematic views of manufacturing a color filter structure 300 according to one embodiment of the present disclosure.

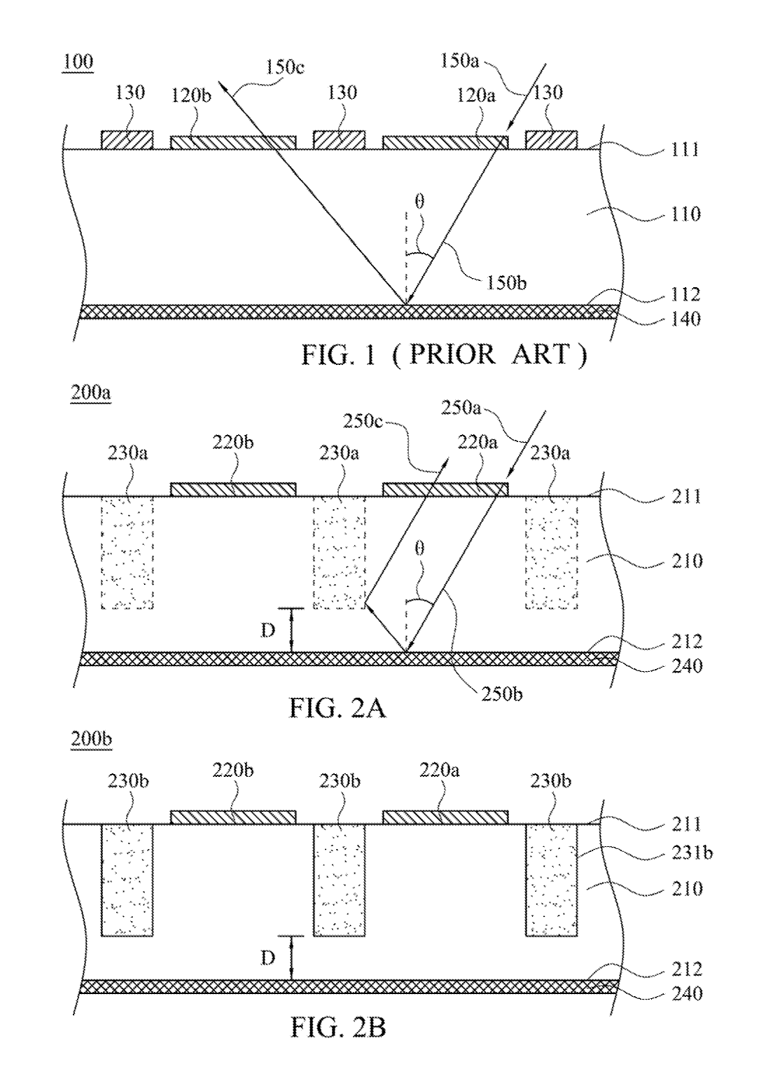

### DETAILED DESCRIPTION

The embodiments of the embedded package structure and a method for manufacturing the same of the present disclosure are discussed in detail below, but not limited the scope of the present disclosure. The same symbols or numbers are used to the same or similar portion in the drawings or the description. And the applications of the present disclosure are not limited by the following embodiments and embodiments which the person in the art can apply in the related field.

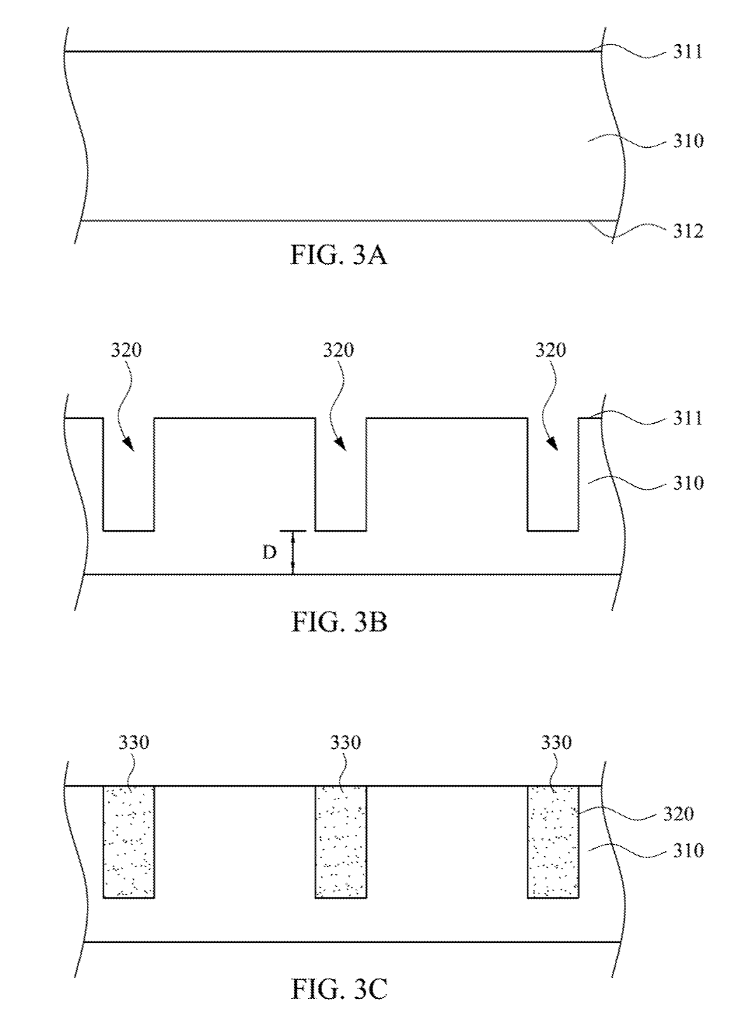

FIG. 2A is a schematic view of a color filter structure 200a according to one embodiment of the present disclosure. In FIG. 2A, the color filter structure 200a comprises a transparent substrate 210, a first color resist 220a, a second color resist 220b, a plurality of light-impermeable structures 230a and a reflective layer 240.

The transparent substrate 210 has a top surface 211 and a bottom surface 212, and the first color resist 220a and the second color resist 220b are positioned on the top surface 211 of the transparent substrate 210. In which, the first color resist 220a and the second color resist 220b are red resist, green resist or blue resist, and the color of the first color resist 220a is different from the second color resist 220b. According to one embodiment of the present disclosure, the material of the transparent substrate 210 comprises glass or a flexible material. According to another embodiment of the present disclosure, the flexible material is polymethylmethacrylate (PMMA), polycarbonate (PC), polyethylene terephthalate (PET) or polyamide (PA).

The light-impermeable structures 230a are positioned in the transparent substrate 210, wherein the first color resist 220a and the second color resist 220b are separated by one of the light-impermeable structures 230a. In which, the cross-sectional view of the light-impermeable structures 230a may be in rectangular shape, trapezoidal shape, triangular shape, inverted trapezoidal shape, inverted triangular shape or bullet shape, but it is not limited in need of light-resistant or reflective design. According to one embodiment of the present disclosure, the light-impermeable structures 230a are formed by diffusing or inserting a light-impermeable material into the transparent substrate 210. According to one embodiment of the present disclosure, the color filter structure further comprises a distance (D) between the bottom of the light-impermeable structure 230a and the bottom surface 212 of the transparent substrate 210, to prevent the transmission of reflective light. According to another embodiment of the present disclosure, the distance (D) between the bottom of the light-impermeable structure 230a and the bottom surface 212 of the transparent substrate 210 is equal to or less than 10 μm.

The reflective layer 240 is positioned on the bottom surface 212 of the transparent substrate 210. According to one embodiment of the present disclosure, the reflective layer 240 is a metal layer or an electro-phoretic display layer. According to one embodiment of the present disclosure, the reflective layer 240 contacts the bottom surface 212 of the transparent substrate 210.

In FIG. 2A, when an extraneous light 250a transmits the first color resist 220a, the extraneous light 250a may change to be a first chromatic light 250b. In which, the first chromatic light 250b has the color of the first color resist 220a. And then, the first chromatic light 250b is reflected to the light-impermeable structures 230a by the reflective layer 240, so as to form a reflective light 250c. In FIG. 2A, θ is the incidence angle of the first chromatic light 150b. According to one embodiment of the present disclosure, the reflective light 250c can be completely absorbed by the light-impermeable structures 230a. According to one embodiment of the present disclosure, part of the reflective light 250c can be absorbed by the light-impermeable structures 230a, and the residual reflective light 250c may transmits the first color resist 220a.

According to one embodiment of the present disclosure, an electro-phoretic display device has the color filter structure 200a as shown in FIG. 2A. According to another embodiment of the present disclosure, a reflective-LCD has the color filter structure 200a as shown in FIG. 2A.

According to one embodiment of the present disclosure, the top surface 211 of the transparent substrate 210 further comprises a plurality of recess structures 231b, and at least one light-impermeable material 230b is filled into the recess structures 231b, so as to form the light-impermeable structures 230a shown in FIG. 2A, as shown in FIG. 2B. In which, the color filter structure further comprises a distance (D) between the bottom of the recess structures 231b and the bottom surface 212 of the transparent substrate 210, to prevent the transmission of reflective light, and the distance (D) is equal to or less than 10 μm.

In FIG. 2B, the light-impermeable material 230b of the color filter structure 200b may be in a single color or vertically gradated colors, so as to present a specific optical effect, and the material thereof may be a resin or chromium oxide (Cr₂O₃), but not be limited. According to one embodiment of the present disclosure, the light-impermeable material is a white resin, and the reflective light may be reflective light by the white light-impermeable material, and then transmits the first color resist, so as to enhance the brightness. According to one embodiment of the present disclosure, the light-impermeable material is a black resin, and the reflective light may be absorbed by the black light-impermeable material, so as to decrease the brightness.

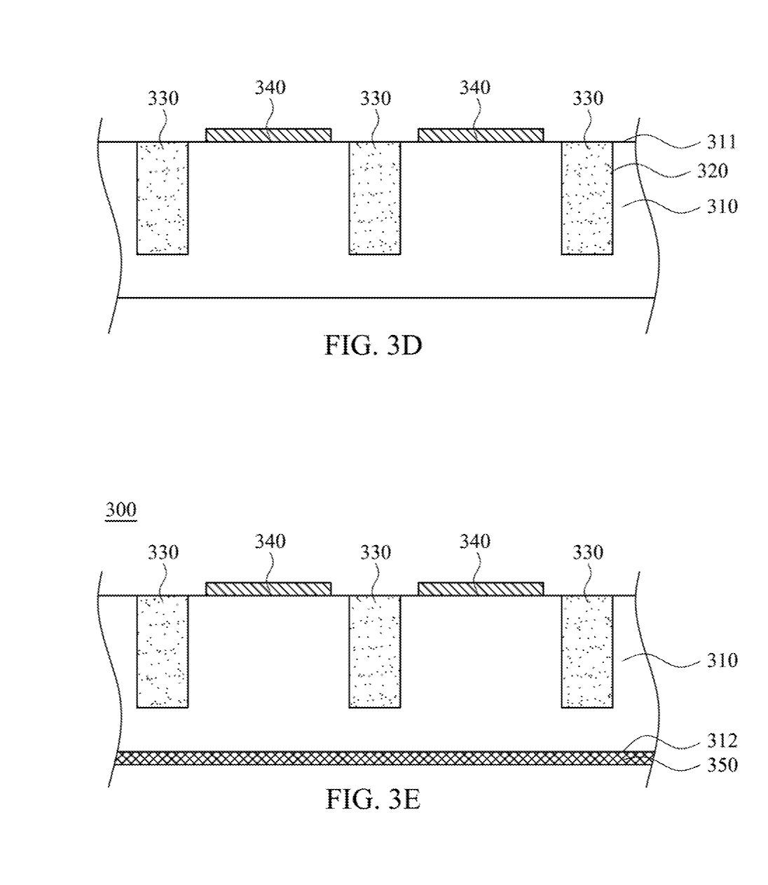

FIG. 3A˜3E are schematic views of manufacturing a color filter structure 300 according to one embodiment of the present disclosure.

In FIG. 3A, a transparent substrate 310 is first provided, which has a top surface 311 and a bottom surface 312. And then a plurality of recess structures 320 are formed in the top surface 311 of the transparent substrate 310, as shown in FIG. 3B. In which, the cross-sectional view of the recess structure 320 may be in rectangular shape, trapezoidal shape, triangular shape, inverted trapezoidal shape, inverted triangular shape or bullet shape, but it is not limited in need of light-resistant or reflective design.

According to one embodiment of the present disclosure, the material of the transparent substrate 310 comprises glass or a flexible material. When the material of the transparent substrate 310 is glass, the step of forming the recess structures 320 comprises an etching method. When the material of the transparent substrate 310 is a flexible material, the step of forming the recess structures 320 comprises a rolling forming method. According to one embodiment of the present disclosure, the flexible material is polymethylmethacrylate (PMMA), polycarbonate (PC), polyethylene terephthalate (PET) or polyamide (PA).

In FIG. 3C, the light-impermeable material 330 is filled into the recess structures 320. According to one embodiment of the present disclosure, the light-impermeable material 330 may be in a single color or vertically gradated colors, so as to present a specific optical effect, and the material thereof may be a resin or chromium oxide (Cr₂O₃), but not be limited. According to another embodiment of the present disclosure, the light-impermeable material 330 is a black resin or a white resin. According to one embodiment of the present disclosure, the step of filling a light-impermeable material 330 into the recess structures 320 comprises a printing process or a filling process, but not be limited.

In FIG. 3D, a plurality of color resists 340 are formed on the top surface 311 of the transparent substrate 310, wherein two of the adjacent color resists 340 are spaced by the light-impermeable material 330 filled in the recess structures 320. According to one embodiment of the present disclosure, the color resists 340 comprises red resists, green resists and blue resists.

And then, a reflective layer 350 is formed on the bottom surface 312 of the transparent substrate 310, so that the color filter structure 300 is provided, as shown in FIG. 3E. According to one embodiment of the present disclosure, the reflective layer 350 is a metal layer or an electro-phoretic display film.

Different from the conventional color filter structure, the color filter structure provided by embodiments of the present disclosure improves the color shift generated by scattering light among different color resists, by forming light-impermeable structures in the transparent substrate. Therefore, in a reflective display device, the color filter provided by embodiments of the present disclosure solves the persistent color shift in the conventional color filter.

Otherwise, compared to the conventional color filter structure, the light-impermeable structures of the transparent substrate in one embodiment of the present disclosure can be used to replace the conventional black matrixes. And, the light-impermeable structures provided by one embodiment of the present disclosure can not only solve the color shift in the color filter structure, but also improve the color and optical performance of a display device.

Although embodiments of the present disclosure and their advantages have been described in detail, they are not used to limit the present disclosure. It should be understood that various changes, substitutions and alterations can be made herein without departing from the spirit and scope of the present disclosure. Therefore, the protecting scope of the present disclosure should be defined as the following claims.

What is claimed is:

1. A color filter structure for a reflective display device, the color filter structure comprising:
a transparent substrate hawing a top surface and a bottom surface;
a plurality of color resists positioned on the top surface of the transparent substrate;
a plurality of light-impermeable structures positioned in the transparent substrate, wherein two of the adjacent color resists are separated by one of the light-impermeable structures; and
a reflective layer positioned on the bottom surface of the transparent substrate.

2. The color filter structure of claim 1, wherein the transparent substrate is made of glass or a flexible material.

3. The color filter structure of claim 2, wherein the flexible material is polymethylmethacrylate (PMMA), polycarbonate (PC), polyethylene terephthalate (PET) or polyamide (PA).

4. The color filter structure of claim 1, wherein the top surface of the transparent substrate further comprises a plurality of recess structures, and at least one light-impermeable material is filled in the recess structures to form the light-impermeable structures.

5. The color filter structure of claim 4, wherein the light-impermeable material is in a single color or vertically gradated colors.

6. The color filter structure of claim 5, wherein the color of the light-impermeable material is white or black.

7. The color filter structure of claim 4, wherein the light-impermeable material is a resin or chromium oxide (Cr₂O₃).

8. The color filter structure of claim 1, wherein the color resists comprises red resists, green resists and blue resists.

9. The color filter structure of claim 1, wherein the reflective layer is a metal layer or an electro-phoretic display film.

10. The color filter structure of claim 1, further comprising a distance between the bottom of the light-impermeable structure and the bottom surface of the transparent substrate, to prevent the transmission of reflective light.

11. The color filter structure of claim 10, wherein the distance is equal to or less than 10 μm.

12. A method of manufacturing a color filter structure, comprising the steps of:
providing a transparent substrate having a top surface and a bottom surface;
forming a plurality of recess structures in the top surfaces of the transparent substrate;
filling a light-impermeable material into the recess structures;
forming a plurality of color resists on the top surface of the transparent substrate, wherein two of the adjacent color resists are separated by the light-impermeable material filled in the recess structures; and
forming a reflective layer on the bottom surface of the transparent substrate.

13. The method of claim 12, wherein the transparent substrate is made of glass or a flexible material.

14. The method of claim 13, when the transparent substrate is made of glass, the step of forming the recess structures comprises an etching method.

15. The method of claim 13, when the transparent substrate is made of the flexible material, the step of forming the recess structures comprises a rolling forming method.

16. The method of claim 12, wherein the step of filling a light-impermeable material into the recess structures comprises a printing process or a filling process.

17. The method of claim 12, wherein the color resists comprises red resists, green resists and blue resists.

18. The method of claim 12, wherein the reflective layer is a metal layer or an electrophoretic display film.

19. The method of claim 12, further comprising a distance preventing the transmission of a reflective light between the bottom of the light-impermeable structure and the bottom surface of the transparent substrate

20. The method of claim 19, wherein the distance is equal to or less than 10 μm.
